(19) United States
(12) Patent Application Publication
(10) Pub. No.: US 2007/0075595 A1
(43) Pub. Date: Apr. 5, 2007

(54) Motor frame having embedded cooling coil

(76) Inventors: Rajmohan Narayanan, Greer, SC (US); Qimin J. Dong, Greer, SC (US)

Correspondence Address: ROCKWELL AUTOMATION, INC./(AT), ATTENTION: SUSAN M. DONAHUE, 1201 SOUTH SECOND STREET, MILWAUKEE, WI, 53204, US

(21) Appl. No.: 11/241,015

(22) Filed: Sep. 30, 2005

(51) Int. Cl. H02K 3/24; H02K 9/00

(52) U.S. Cl. 310/52

(57) ABSTRACT

A method of manufacturing an apparatus, such as a motor or other rotating machine, having a cooling coil is provided. The exemplary method includes disposing a cooling coil within a casting mold and casting a component of the device such that the cooling coil is embedded within the component. A coolant is routed through the cooling coil during the casting process to reduce or prevent melting of the cooling coil and preserve a fluid conduit within the cooling coil. A device component and apparatus having a cooling coil are also provided.

### BACKGROUND

The present invention generally relates to heat-generating devices and machines, including rotating machines such as electric induction motors. More particularly, the present invention relates to a technique for embedding a cooling coil or conduit in a device or machine component to promote heat dissipation from the device or machine.

Rotating machines of various types are commonly found in industrial, commercial and consumer settings. For instance, in industry, motors are employed to drive various kinds of machinery, such as pumps, conveyors, compressors, fans and so forth, to mention only a few. Conventional alternating current (ac) electric motors may be constructed for single- or multiple-phase power, and are typically designed to operate at predetermined speeds or revolutions per minute (rpm), such as 3600 rpm, 1800 rpm, 1200 rpm, and so on. Such motors generally include a stator comprising a multiplicity of windings surrounding a rotor, which is supported by bearings for rotation in the motor frame. Typically, the rotor comprises a core formed of a series of magnetically conductive laminations arranged to form a lamination stack capped at each end by electrically conductive end rings. Additionally, typical rotors include a series of conductors that are formed of a nonmagnetic, electrically conductive material and that extend through the rotor core. These conductors are electrically coupled to one another via the end rings, thereby forming one or more closed electrical pathways.

In the case of ac motors, applying ac power to the stator windings induces a current in the rotor, specifically in the conductors. That is, at a given point in time, alternating levels and polarities of current are routed through the various coil windings. This varied routing of current results in a dynamic electromagnetic field that induces rotation of the rotor. The speed of this rotation is typically a function of the frequency of ac input power (i.e., frequency) and of the motor design (i.e., the number of poles defined by the stator windings). A rotor shaft extending through the motor housing takes advantage of this produced rotation and translates the movement of the rotor into a driving force for a given piece of machinery. That is, rotation of the shaft drives the machine to which it is coupled.

As will be appreciated, transmission of electricity through the windings of a motor, or the circuitry of an electronic device, and friction between moving and stationary components within devices generate heat, which may interfere with proper operation of the motor or other device. Further, in the case of a motor, heat may be transmitted to the motor from external devices or components coupled to the motor, such as a mining drill driven by a motor. While some devices may adequately dissipate such heat through passive cooling techniques, other devices create more heat than can be effectively dissipated through such techniques. Particularly, in certain demanding applications for motors, such as high speed operation and mining activities, active cooling techniques are desirable to adequately dissipate heat from the motor and facilitate proper operation of the motor. However, inclusion of active cooling systems increases the time, labor, and expense of producing such motors and other devices.

There exists, therefore, a need for machines and devices having efficient cooling systems and an improved technique for producing such systems efficiently while reducing manufacturing costs of the systems.

### BRIEF DESCRIPTION

In accordance with certain embodiments, the present technique provides a device component having a cooling coil embedded in a cast body of the component. The cooling coil includes an internal conduit or passage for transmission of a cooling material through the cooling coil. The cooling coil material has a melting point substantially equal to or less than the melting point of the material of the cast body. Heat is transferred from the device to the cooling material and is thereby removed from the component. The cooling material may be any material with suitable thermal characteristics, including various fluids or gases. By way of example, the device component may be a motor frame having a serpentine or helical cooling coil.

In accordance with another embodiment, the present technique provides a rotating machine having an internal cooling coil embedded within a frame of the machine. The frame material has a melting point generally equal to or greater than the melting point of the cooling coil. A coolant may be routed through the cooling coil to dissipate heat present during operation of the machine. The exemplary apparatus also includes a rotor and stator core disposed within the frame.

Additionally, the present technique provides an exemplary method for manufacturing a device having an embedded cooling coil for dissipating heat in the device. The exemplary method includes the act of disposing a cooling coil in a casting mold for a device component. The method also includes casting the device component in the mold having the cooling coil and circulating a coolant through the cooling coil during at least a portion of the casting step. This results in a device component having the cooling coil embedded within the component, facilitating active cooling of the component during operation.

### DRAWINGS

These and other features, aspects, and advantages of the present invention will become better understood when the following detailed description is read with reference to the accompanying drawings in which like characters represent like parts throughout the drawings, wherein:

FIG. 1 is a perspective view of an exemplary motor, in accordance with one embodiment of the present invention;

FIG. 2 is a perspective view of the motor frame of FIG. 1 illustrating additional features of the motor frame, including a serpentine cooling coil embedded within the motor frame in accordance with one embodiment of the present techniques;

FIG. 3 is a partial cross-sectional view of the exemplary motor of FIG. 1 taken along the line 3-3;

FIG. 4 is a perspective view of a motor frame in accordance with an alternative embodiment of the present invention, the exemplary motor frame including a helical cooling coil embedded within the frame to transfer heat from a machine; and

FIG. 5 is a flowchart indicative of an exemplary method of manufacturing a machine frame having an embedded cooling coil in accordance with an embodiment of the present techniques.

### DETAILED DESCRIPTION

As discussed in detail below, certain embodiments of the present invention provide components, apparatus, and methods for motors and motor construction. Although the following discussion focuses on induction motors, the present invention also affords benefits to a number of applications, including not only those involving other types of electric motors, such as direct current (dc) motors, or rotating machines, but also those involving heat-generating devices outside the field of motors and rotating machines. Accordingly, the following discussion provides exemplary embodiments of the present invention and, as such, should not be viewed as limiting the appended claims to the embodiments described.

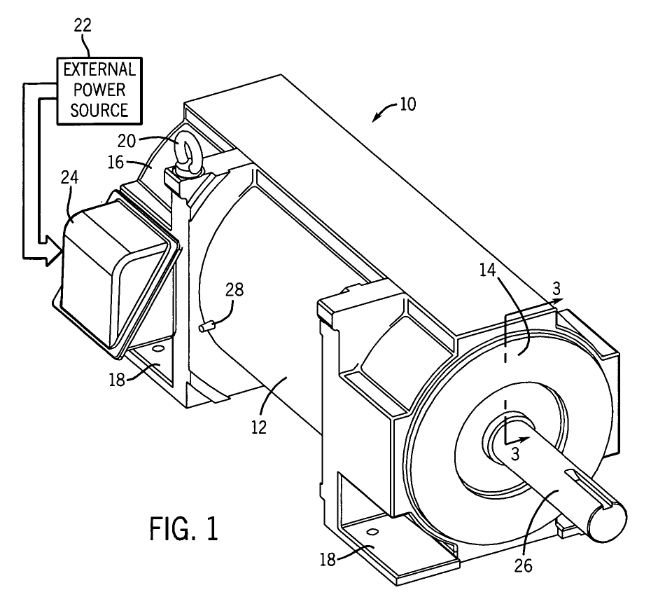

Turning to the drawings, FIG. 1 illustrates an exemplary electric motor 10. In the embodiment illustrated, the motor 10 comprises an induction motor housed in a National Electrical Manufacturers' Association (NEMA) motor housing. As appreciated by those of ordinary skill in the art, associations such as NEMA develop particular standards and parameters for the construction of motor housings or enclosures. The exemplary motor 10 comprises a frame 12 capped at each end by front and rear endcaps 14 and 16, respectively. The frame 12 and the front and rear endcaps 14 and 16 cooperate to form the enclosure or motor housing for the motor 10. The frame 12 and the front and rear endcaps 14 and 16 may be formed of any number of materials, such as steel, aluminum, or any other suitable structural material. The endcaps 14 and 16 may include mounting and transportation features, such as the illustrated mounting flanges 18 and eyehooks 20. Those skilled in the art will appreciate in light of the following description that a wide variety of motor configurations and devices may employ the techniques outlined below.

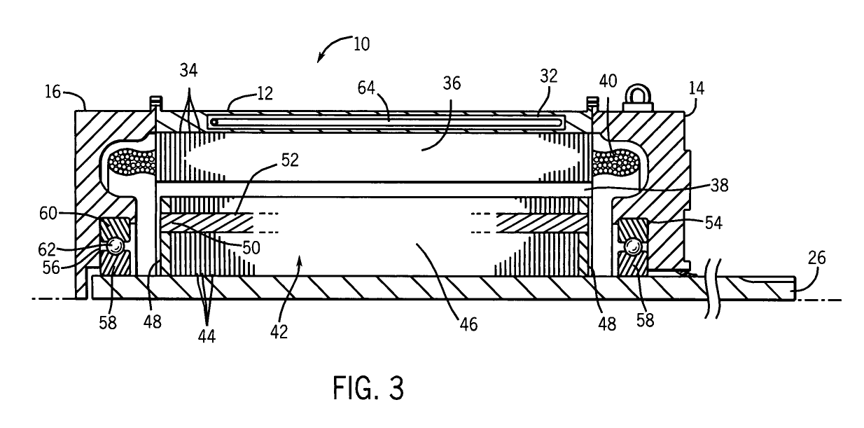

To induce rotation of the rotor, current is routed through stator windings disposed in the stator, such as those illustrated in FIG. 3. Stator windings are electrically interconnected to form groups, which are, in turn, interconnected in a manner generally known in the pertinent art. The stator windings are further coupled to terminal leads (not shown), which electrically connect the stator windings to an external power source 22, such as 480 Vac three-phase power or 110 Vac single-phase power. As another example, the external power source 22 may comprise an ac pulse width modulated (PWM) inverter. A conduit box 24 houses the electrical connection between the terminal leads and the external power source 22. The conduit box 24 comprises a metal or plastic material and, advantageously, provides access to certain electrical components of the motor 10.

Routing electrical current from the external power source 22 through the stator windings produces a magnetic field that induces rotation of the rotor. A rotor shaft 26 coupled to the rotor rotates in conjunction with the rotor. That is, rotation of the rotor translates into a corresponding rotation of the rotor shaft 26. As appreciated by those of ordinary skill in the art, the rotor shaft 26 may couple to any number of drive machine elements, thereby transmitting torque to the given drive machine element. By way of example, machines such as pumps, compressors, fans, conveyors, and so forth, may harness the rotational motion of the rotor shaft 26 for operation.

Notably, as discussed in greater detail below, frame 12 includes an internal cooling coil for dissipating heat generated by motor 10. Accordingly, frame 12 includes an inlet port 28 for introduction of a cooling material, such as a fluid or a gas, within the cooling coil.

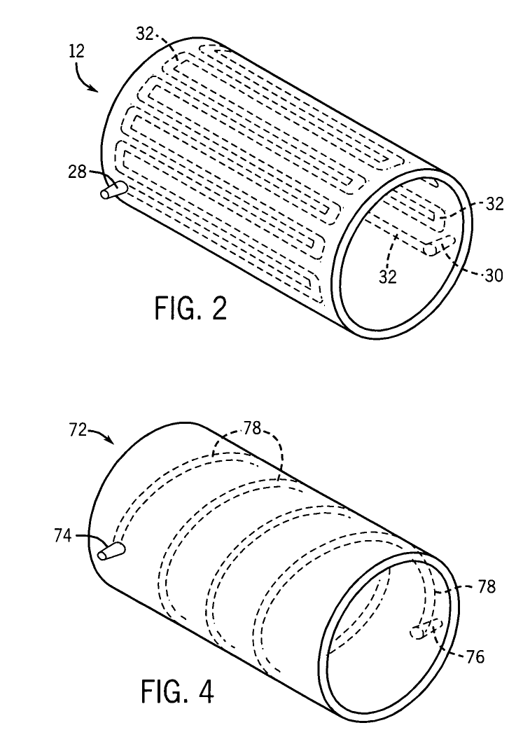

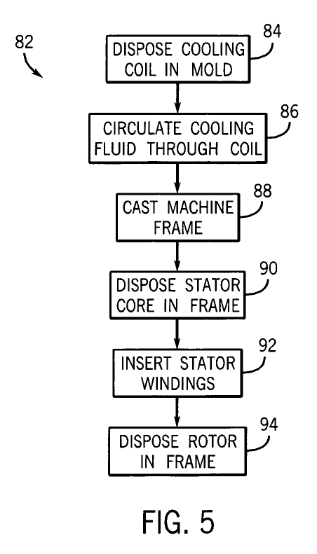

Additional features of exemplary motor frame 12, including certain internal features, are illustrated in FIG. 2. As will be appreciated by those skilled in the art, exemplary motor 10 produces heat during operation. Particularly, among other causes, routing of electrical power through the windings results in heat generation, as does the friction between the rotating and stationary components of motor 10. Accordingly, a cooling coil 32 is provided within frame 12 to dissipate such heat. Frame 12 may be formed from various materials, including steel, aluminum, iron, and other metals. In some embodiments, cooling coil 32 may be formed from the same material as frame 12, but any number of different suitable materials with sufficient thermal conductivity may be used for the cooling coil of other embodiments, including copper, aluminum, metal alloys, thermoconductive ceramics, or the like. In certain embodiments, the melting point of the cooling coil material may be generally equal to or less than the melting point of the frame material, as provided below with respect to FIG. 5. A coolant may be introduced into the cooling coil 32 through inlet port 28 and travel through the cooling coil 32 before exiting outlet port 30.

It should be noted that cooling coil 32 may be configured to transmit various coolants. While water is used in one embodiment, utilization of other fluids or gases is also envisaged. When circulated through cooling coil 32, the coolant extracts heat from the system through convection, conduction, or a combination thereof, thereby dissipating heat generated by, or otherwise present in, motor 10. Further, it should also be noted that, while cooling coil 32 is generally serpentine or labyrinthine in shape, other embodiments may include cooling coils of other shapes, such as the helical cooling coil illustrated in FIG. 4 and discussed below. Still further, the present techniques encompass the use of cooling coils having different cross-sectional profiles. For instance, although one embodiment may utilize a round cooling coil having a generally circular cross-section, other embodiments may utilize cooling coils of different shapes, including those presenting rectangular cross-sections, those having ribs or indentations formed on or in cooling coil, or those of other various shapes. As will be appreciated, a cooling coil of a particular shape may be selected for particular structural or thermal properties desired for a particular application in full accordance with the present techniques.

FIG. 3 is a partial cross-sectional view of the motor 10 of FIG. 1 along line 3-3. To simplify the discussion, only the top portion of the motor 10 is shown. As discussed above, the frame 12 and the front and rear endcaps 14 and 16 cooperate to form an enclosure or motor housing for the motor 10. Within the enclosure or motor housing resides a plurality of stator laminations 34 juxtaposed and aligned with respect to one another to form a lamination stack, such as a contiguous stator core 36. In the exemplary motor 10, the stator laminations 34 are substantially identical to one another, and each includes features that cooperate with adjacent laminations to form cumulative features for the contiguous stator core 36. For example, each stator lamination 34 includes a central aperture that cooperates with the central aperture of adjacent laminations to form a rotor chamber 38 that extends the length of the stator core 36 and that is sized to receive a rotor. Additionally, each stator lamination 34 includes a plurality of stator slots disposed circumferentially about the central aperture. These stator slots cooperate to receive one or more stator windings 40, which are illustrated as end turns in FIG. 3, that extend the length of the stator core 36.

In the exemplary motor 10, a rotor assembly 42 resides within the rotor chamber 38. Similar to the stator core 36, the rotor assembly 42 comprises a plurality of rotor laminations 44 aligned and adjacently placed with respect to one another. Thus, the rotor laminations 44 cooperate to form a contiguous rotor core 46. The exemplary rotor assembly 42 also includes rotor end members 48, disposed on each end of the rotor core 46, that cooperate to secure the rotor laminations 44 with respect to one another. When assembled, the rotor laminations 44 cooperate to form shaft chamber that extends through the center of the rotor core 46 and that is configured to receive the rotor shaft 26 therethrough. The rotor shaft 26 is secured with respect to the rotor core 46 such that the rotor core 46 and the rotor shaft 26 rotate as a single entity, the rotor assembly 42.

The exemplary rotor assembly 42 also includes electrically conductive nonmagnetic members, such as rotor conductor bars 50, disposed in the rotor core 46. Specifically, the conductor bars 50 are disposed in rotor channels 52 that are formed by amalgamating features of each rotor lamination 44. As will be appreciated by one skilled in the art, inducing current in the rotor assembly 42, specifically in the conductor bars 50, causes the rotor assembly 42 to rotate. By harnessing the rotation of the rotor assembly 42 via the rotor shaft 26, a machine coupled to the rotor shaft 26, such as a pump or conveyor, may operate.

To support the rotor assembly 42, the exemplary motor 10 includes front and rear bearing sets 54 and 56, respectively, that are secured to the rotor shaft 26 and that facilitate rotation of the rotor assembly 42 within the stationary stator core 36. During operation of the motor 10, the bearing sets 54 and 56 transfer the radial and thrust loads produced by the rotor assembly 42 to the motor housing. Each bearing set 54 and 56 includes an inner race 58 disposed circumferentially about the rotor shaft 26. The tight fit between the inner race 58 and the rotor shaft 26 causes the inner race 58 to rotate in conjunction with the rotor shaft 26. Each bearing set 54 and 56 also includes an outer race 60 and ball bearings 62, which are disposed between the inner and outer races 58 and 60. The ball bearings 62 facilitate rotation of the inner races 58 while the outer races 60 remain stationary and mounted with respect to the endcaps 14 and 16. Thus, the bearing sets 54 and 56 facilitate rotation of the rotor assembly 42 while supporting the rotor assembly 42 within the motor housing, i.e., the frame 12 and the endcaps 14 and 16. To reduce the coefficient of friction between the races 58 and 60 and the ball bearings 62, the ball bearings 62 are coated with a lubricant.

As discussed above, the exemplary motor 10 produces heat during operation and cooling coil 32 is provided within frame 12 to dissipate such heat. Cooling coil 32 defines a conduit or passageway 64 that enables a coolant to be routed through the cooling coil within frame 12. As noted above, any suitable coolant may be used, such as water, another fluid, or a gas. This coolant absorbs heat from the motor via frame 12 and cooling coil 32. The coolant is then routed from the motor 10, such as through outlet port 30 (FIG. 2), thereby reducing heat in the motor 10.

As will be appreciated, other cooling arrangements may be employed in accordance with the present techniques. For instance, an alternative motor frame 72 is illustrated in FIG. 4. Frame 72 includes an inlet port 74 and an outlet port 76 that are coupled to one another via a cooling coil 78. However, unlike the serpentine cooling coil 32 of FIG. 2, cooling coil 78 is generally helical. Consequently, coolant introduced into cooling coil 78 follows a generally spiral path through frame 72 before exiting outlet port 76. Indeed, as noted above, the present techniques may find a wide range of applicability beyond frames of motors or other rotating machines. Instead, the present techniques may be applied to any number of other components or devices that generate heat during operation and may benefit from the techniques disclosed herein.

An exemplary method 82 for manufacturing an apparatus, such as a motor, having an embedded cooling coil is provided in FIG. 5. Method 82 includes disposing a cooling coil in a casting mold for a component of the apparatus, as indicated in block 84, and circulating a coolant, such as a fluid or gas, through the coil, as indicated in block 86. As noted previously, the cooling coil is made from a thermally conductive material, such as copper. As may be appreciated, the temperature of any material cast in the mold might exceed the melting point of the material forming the cooling coil. However, in such an instance, the circulation of coolant through the coil buttresses the structural integrity of the coil by removing heat from the coil during the casting of the machine frame or other component, as indicated in block 88. In the case of a motor frame, once the cast frame cools, a stator core may be disposed in the frame, as indicated in block 90, stator windings may be inserted into the stator core, as indicated in block 92, and a rotor assembly may be disposed in the frame, as indicated in block 94. In this manner, a rotating machine or other device may be manufactured that provides an efficient cooling system while reducing the manufacturing expense of such a component or apparatus.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A device component comprising:
a cast body comprising a first material; and
a cooling coil embedded within the body, the cooling coil comprising a second material and having an internal passage configured for transmission of a cooling material through the cooling coil to transfer heat generated by components of a device away from the device, wherein the second material has a melting point substantially equal to or less than a melting point of the first material.

2. The component of claim 1, wherein the cooling coil comprises copper.

3. The component of claim 1, wherein the cooling coil comprises aluminum.

4. The component of claim 1, wherein the body comprises steel.

5. The component of claim 1, wherein the body comprises a frame of a rotating machine.

6. The component of claim 1, wherein the internal passage is substantially serpentine.

7. The component of claim 1, wherein the internal passage is substantially helical.

8. A rotating machine comprising:
a frame configured to house components of a rotating machine, the frame comprising a first material;
a rotor disposed in the frame;
a stator core disposed in the frame, the stator core having a central aperture configured to receive the rotor and a plurality of slots disposed circumferentially about the central aperture and configured to receive a plurality of stator windings; and
an internal cooling coil embedded within the frame, the internal cooling coil comprising a second material different than the first material and defining a closed passageway for routing a cooling material through the frame to extract heat from the components, wherein a melting point of the first material is substantially equal to or greater than a melting point of the second material.

9. The rotating machine of claim 8, wherein the first material comprises steel.

10. The rotating machine of claim 8, wherein the second material comprises copper.

11. The rotating machine of claim 8, wherein the second material comprises aluminum.

12. The rotating machine of claim 8, wherein the internal cooling coil is substantially helical.

13. A method for manufacturing an apparatus, the method comprising:
disposing a cooling coil within a component mold;
casting a component of a device in the component mold such that cooling coil is embedded within the component; and
circulating a cooling material through the cooling coil during at least a portion of the casting of the component.

14. The method of claim 13, wherein the cooling coil comprises a first material having a melting point substantially equal to or less than a second material cast in the component mold.

15. The method of claim 13, wherein the cooling material is a fluid.

16. The method of claim 13, wherein the component is a frame of the apparatus.

17. The method of claim 16, wherein the apparatus is a rotating machine.

18. The method of claim 17, further comprising:
disposing a stator core in the frame, the stator core having a plurality of slots configured to receive a plurality of stator windings;
inserting the stator windings into the stator core; and
disposing a rotor in the frame.

19. The method of claim 17, wherein the rotating machine is a motor.

20. The method of claim 13, wherein the cooling coil comprises a generally labyrinthine passageway for transmission of a cooling material.

21. The method of claim 13, wherein the cooling coil comprises a generally helical passageway for transmission of a cooling material.
